(19) United States
(12) Patent Application Publication
(10) Pub. No.: US 2018/0060333 A1
(43) Pub. Date: Mar. 1, 2018

(54) SYSTEM AND METHOD FOR PLACEMENT OF VIRTUAL CHARACTERS IN AN AUGMENTED/VIRTUAL REALITY ENVIRONMENT

(71) Applicant: GOOGLE INC., Mountain View, CA (US)

(72) Inventors: Robert BOSCH, Santa Cruz, CA (US); Ibrahim ELBOUCHIKHI, Belmont, CA (US)

(21) Appl. No.: 15/679,527

(22) Filed: Aug. 17, 2017

Related U.S. Application Data
(60) Provisional application No. 62/378,510, filed on Aug. 23, 2016.

(51) Int. Cl. G06F 17/30; G02B 27/01; H04L 29/06

(52) U.S. Cl. CPC G06F 17/30061; G02B 27/017; G06T 19/00; A63F 2300/534; A63F 2300/5533; H04L 67/38

(57) ABSTRACT

A system and method for orienting the presentation of a virtual environment with respect to multiple users in a shared virtual space is provided. The multiple users may be physically present in different physical spaces. For each of the multiple users, the system may detect physical constraints associated with the respective physical space, and may determine a longest, unobstructed physical path in the physical space based on an orientation of the user in the physical space and the associated physical constraints. A presentation of the virtual environment to the multiple users in the shared virtual space may then be oriented with respect to each of the multiple users so as to maximize interaction amongst the multiple users in the shared virtual space.

### CROSS REFERENCE TO RELATED APPLICATION

This application is a Non-Provisional of, and claims priority to, U.S. Provisional Application No. 62/378,510, filed on Aug. 23, 2016, the disclosure of which is incorporated by reference herein in its entirety.

FIELD

This document relates, generally, to a system and method for placing virtual characters in an augmented and/or virtual reality environment.

### BACKGROUND

In an augmented reality (AR) and/or a virtual reality (VR) system generating a virtual reality environment to be experienced by one or more users, multiple users may share and/or virtually occupy the same virtual space when immersed in a shared virtual experience. The multiple users in the shared virtual space may interact with each other, as well as with virtual elements and/or objects and/or features in the virtual environment using various electronic devices, such as, for example, a helmet or other head mounted device including a display, glasses or goggles that a user looks through when viewing a display device, external handheld devices that include sensors, gloves fitted with sensors, and other such electronic devices. Obstacles in the real world space and/or boundaries of the real world space in which the AR/VR system is operating may affect the ability of the multiple users to interact effectively with each other.

### SUMMARY

In one aspect, a method may include detecting at least one physical constraint associated with a first physical space; detecting, based on a position and an orientation of a first user in the first physical space and the detected at least one physical constraint associated with the first physical space, a first physical path in the first physical space; detecting at least one physical constraint associated with a second physical space; detecting, based on a position and an orientation of a second user in the second physical space and the detected at least one physical constraint associated with the second physical space, a second physical path in the second physical space; displaying a virtual environment to the first user at a first orientation with respect to the first user, and displaying the virtual environment to the second user at a second orientation with respect to the second user, the virtual environment being presented to the first and second users in a shared virtual space, including: orienting virtual features of the virtual environment with respect to the first user in the shared virtual space based on the first physical path, a context of the virtual environment presented in the shared virtual space, and a first virtual path in the shared virtual space; and orienting the virtual features of the virtual environment with respect to the second user in the shared virtual space based on the second physical path, the context of the virtual environment presented in the shared virtual space, and a second virtual path in the shared virtual space.

In another aspect, a computer program product may be embodied on a non-transitory computer readable medium. The computer readable medium may have stored thereon a sequence of instructions which, when executed by a processor, causes the processor to execute a method. The method may include detecting at least one physical constraint associated with a first physical space; detecting a first physical path in the first physical space based on a position and an orientation of a first user in the first physical space and the detected at least one physical constraint associated with the first physical space; detecting at least one physical constraint associated with a second physical space; detecting a second physical path in the second physical space based on a position and an orientation of a second user in the second physical space and the detected at least one physical constraint associated with the second physical space; displaying virtual features of a virtual environment to the first user in a first orientation; and displaying the virtual features of the virtual environment to the second user in a second orientation, the virtual environment being presented to the first and second users in a shared virtual space, the first orientation of the virtual features of the virtual environment with respect to the first user in the shared virtual space being based on the first physical path, a context of the virtual environment, and a first virtual path in the shared virtual space, and the second orientation of the virtual features of the virtual environment with respect to the second user in the shared virtual space being based on the second physical path, the context of the virtual environment presented in the shared virtual space, and a second virtual path in the shared virtual space.

The details of one or more implementations are set forth in the accompanying drawings and the description below. Other features will be apparent from the description and drawings, and from the claims.

### BRIEF DESCRIPTION OF THE DRAWINGS

FIG. 1 is an example implementation of an augmented and/or virtual reality system.

FIGS. 2A and 2B are perspective views of a head mounted display device, in accordance with implementations described herein.

FIG. 3 is a block diagram of an example system providing for placement and orientation of multiple users experiencing a shared virtual space generated by an augmented and/or virtual reality system, in accordance with implementations described herein.

FIGS. 4A-4D and 5A-5B illustrate example implementations of a system for placement and orientation of multiple users experiencing a shared virtual space generated by an augmented and/or virtual reality system, in accordance with implementations described herein.

FIG. 6 is a flowchart of a method of orienting multiple users in a shared virtual space, in accordance with implementations described herein.

FIG. 7 illustrates an example of a computer device and a mobile computer device that can be used to implement the techniques described here.

### DETAILED DESCRIPTION

An Augmented Reality (AR) and/or a Virtual Reality (VR) system may include, for example, a head mounted display (HMD) device or similar device worn by a user, for example, on a head of the user, to generate an immersive virtual environment. The virtual environment may be experienced by the user while in a real world environment, or real world space, with movement of the user in the real world environment translated into corresponding movement in the virtual world environment. Physical constraints in the real world environment may affect a user's ability to move freely in the virtual environment, and to effectively interact with virtual objects, features, elements and the like in the virtual environment. Physical constraints in the real world environment may also affect, or inhibit, effective interaction between multiple users occupying, or sharing, the same virtual environment. These physical constraints may include, for example, physical boundaries such as walls and the like in the real world environment. These physical constraints may also include physical obstacles such as, furniture and the like in the real world environment, other people, pets and the like in the real world environment, and the like. A system and method, in accordance with implementations described herein, may selectively position and orient virtual features of a virtual environment relative to a user, or multiple users in a shared virtual environment, given known physical constraints and/or physical obstacles of the real world environment in which each of the users is physically present. This positioning and orientation may maximize an amount of physical space accessible to the user(s) and enhance interaction with virtual features in the virtual environment and/or other virtual characters sharing the virtual environment. For example, in some implementations, this positioning and orientation may of the virtual features of the virtual environment may draw the user(s) naturally along an unobstructed, three dimensional volume path, allowing for what the system determines to be the greatest amount of uninterrupted physical movement in the physical environment, given the physical constraints and physical obstacles associated with the physical environment. Hereinafter, this volume path may be referred to as a physical path, simply for ease of discussion and illustration.

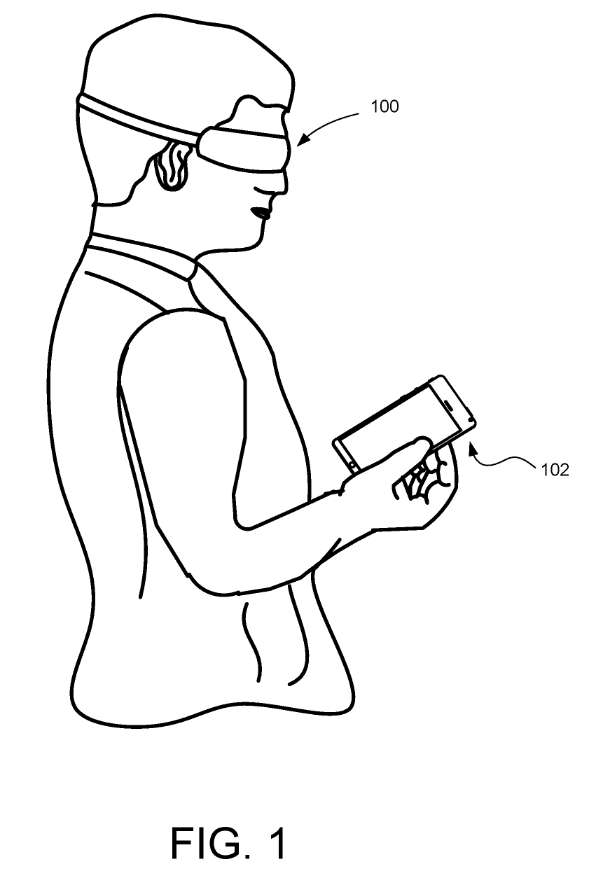

FIG. 1 illustrates one of the multiple users of a system and method, in accordance with implementations described herein. As shown in FIG. 1, a user wearing an HMD 100 is holding a portable, or handheld, electronic device 102, such as, for example, a controller, a smartphone, or other portable handheld electronic device. The handheld electronic device 102 may be paired with, or operably coupled with, and communicate with, the HMD 100 via, for example, a wired connection, or a wireless connection such as, for example, a wifi or Bluetooth connection. This pairing, or operable coupling, may provide for communication and exchange of data between the handheld electronic device 102 and the HMD 100, so that the handheld electronic device 102 may facilitate interaction with and input into the virtual environment generated by the HMD 100.

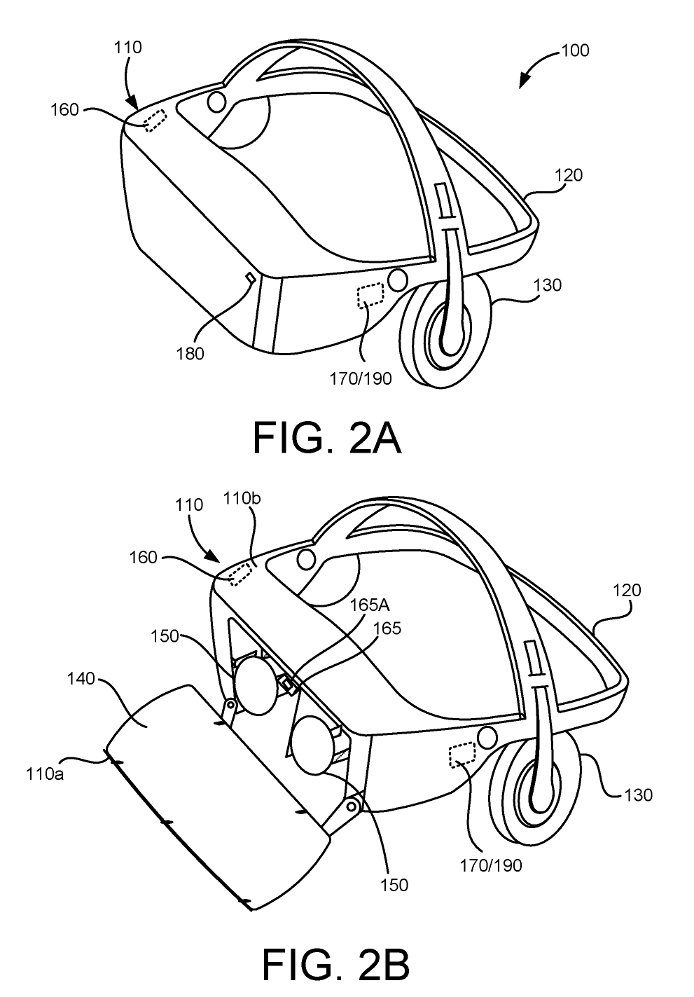

FIGS. 2A and 2B are perspective views of an example HMD, such as, for example, the HMD 100 worn by the user in FIG. 1, to generate an immersive virtual reality environment. The HMD 100 may include a housing 110 coupled, for example, rotatably coupled and/or removably attachable, to a frame 120. An audio output device 130 including, for example, speakers mounted in headphones, may also be coupled to the frame 120. In FIG. 2B, a front face 110a of the housing 110 is rotated away from a base portion 110b of the housing 110 so that some of the components received in the housing 110 are visible. A display 140 may be mounted on the front face 110a of the housing 110. Lenses 150 may be mounted in the housing 110, between the user's eyes and the display 140 when the front face 110a is in the closed position against the base portion 110b of the housing 110. A position of the lenses 150 may be may be aligned with respective optical axes of the user's eyes to provide a relatively wide field of view and relatively short focal length. In some implementations, the HMD 100 may include a sensing system 160 including various sensors and a control system 170 including a processor 190 and various control system devices to facilitate operation of the HMD 100.

In some implementations, the HMD 100 may include a camera 180 to capture still and moving images of the real world environment outside of the HMD 100. In some implementations the images captured by the camera 180 may be displayed to the user on the display 140 in a pass through mode, allowing the user to view images from the real world environment without removing the HMD 100, or otherwise changing the configuration of the HMD 100 to move the housing 110 out of the line of sight of the user.

In some implementations, the HMD 100 may include an optical tracking device 165 including, for example, one or more images sensors 165A, to detect and track user eye movement and activity such as, for example, optical position (for example, gaze), optical activity (for example, swipes), optical gestures (such as, for example, blinks) and the like. In some implementations, the HMD 100 may be configured so that the optical activity detected by the optical tracing device 165 is processed as a user input to be translated into a corresponding interaction in the virtual environment generated by the HMD 100.

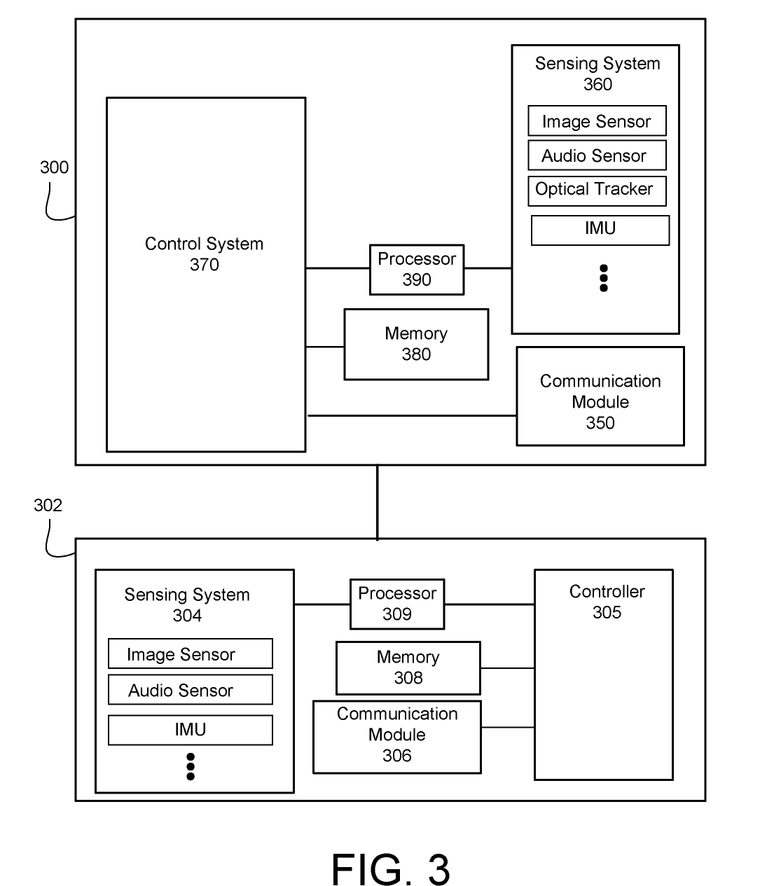

A block diagram of a system for orienting user(s) in a shared virtual environment, in accordance with implementations described herein, is shown in FIG. 3. The system may include a first user electronic device 300. In some implementations, the first user electronic device 300 may be in communication with a second user electronic device 302. The first user electronic device 300 may be, for example an HMD as described above with respect to FIGS. 1, 2A and 2B, generating an immersive virtual environment to be experienced by the user, and the second user electronic device 302 may be, for example, a handheld electronic device as described above with respect to FIG. 1, in communication with the first user electronic device 300, to facilitate user interaction with the virtual immersive environment.

The first electronic device 300 may include a sensing system 360 and a control system 370, which may be similar to the sensing system 160 and the control system 170, respectively, shown in FIGS. 2A and 2B. The sensing system 360 may include numerous different types of sensors, including, for example, a light sensor, an audio sensor, an image sensor, a distance/proximity sensor, an inertial measurement system including for example and accelerometer and gyroscope, and/or other sensors and/or different combination(s) of sensors. In some implementations, the light sensor, image sensor and audio sensor may be included in one component, such as, for example, a camera, such as the camera 180 of the HMD 100 shown in FIGS. 2A and 2B. In some implementations, the sensing system 360 may include an image sensor positioned to detect and track optical activity of the user, such as, for example, a device similar to the optical tracking device 165 shown in FIG. 2B. The control system 370 may include numerous different types of devices, including, for example, a power/pause control device, audio and video control devices, an optical control device, a transition control device, and/or other such devices and/or different combination(s) of devices. In some implementations, the sensing system 360 and/or the control system 370 may include more, or fewer, devices, depending on a particular implementation. The elements included in the sensing system 360 and/or the control system 370 can have a different physical arrangement (e.g., different physical location) within, for example, an HMD other than the HMD 100 shown in FIGS. 2A and 2B.

The first electronic device 300 may also include a processor 390 in communication with the sensing system 360 and the control system 370, a memory 380 accessible by, for example, a module of the control system 370, and a communication module 350 providing for communication between the first electronic device 300 and another, external device, such as, for example, the second electronic device 302 paired to the first electronic device 300.

The second electronic device 302 may include a communication module 306 providing for communication between the second electronic device 302 and another, external device, such as, for example, the first electronic device 300 paired with the second electronic device 302. In addition to providing for the exchange of, for example, electronic data between the first electronic device 300 and the second electronic device 302, in some embodiments, the communication module 306 may also be configured to emit a ray or beam. The second electronic device 302 may include a sensing system 304 including, for example, an image sensor and an audio sensor, such as is included in, for example, a camera and microphone, an inertial measurement unit, a touch sensor such as is included in a touch sensitive surface of a handheld electronic device, and other such sensors and/or different combination(s) of sensors. A processor 309 may be in communication with the sensing system 304 and a controller 305 of the second electronic device 302, the controller 305 having access to a memory 308 and controlling overall operation of the second electronic device 302.

In an augmented and/or virtual reality system, in accordance with implementations described herein, each user may physically move in the user's respective real world environment, or real world space, or room, to cause corresponding movement in the virtual environment. The system may track the user's movement in the real world environment, and may cause perceived movement in the virtual environment in coordination with the user's physical movement in the real world environment. In other words, the movement of the user in the real world environment may be translated into movement in the virtual environment to generate a heightened sense of presence in the virtual environment. In some implementations, a virtual environment may be shared by multiple users. In some implementations, the multiple users in the shared virtual environment may be physically present in the same physical environment. In some implementations, the multiple users in the shared virtual environment may each be physically positioned in their own respective physical environment, while each being virtually present in the shared virtual environment. In the shared virtual environment, the multiple users may interact with each other, may share interaction with virtual features in the virtual environment, and the like. In some implementations, users virtually present in the shared virtual environment may by represented by a virtual character, to further enhance interaction between users in the shared virtual environment.

Multiple users who are virtually present in a shared virtual environment may wish to approach each other in the virtual environment to facilitate interaction between their respective virtual characters. In some situations, a first user in a first real world environment and a second user in a second real world environment may be positioned and oriented with respect to the virtual features of the shared virtual environment such that they cannot approach each other due to physical obstacles positioned in their respective real world environments. This may inhibit effective interaction between the first user and the second user in the virtual environment. In this situation, a virtual teleporting or scrolling action may be implemented to bring the first and second users virtually closer together. The ability for the first and second users to approach each other in the virtual environment while physically moving in their respective real world environments may enhance the virtual experience for each of the users.

Simply for ease of discussion and illustration, the real world environment, or real world space, will hereinafter be considered to be a room, having walls, a floor and a ceiling defining the physical boundaries of the real world environment, with physical objects, posing physical obstacles to movement in the real world environment, positioned throughout the room. In contrast, the virtual environment may be essentially without boundary, with the virtual movement of the user(s) in the virtual environment only limited by the confines, or boundaries, or physical constraints, of the physical room in which the respective user is physically present.

In some implementations, the physical boundaries of the room, for example, the relative positioning of the walls, as well as the positioning of various stationary physical objects (for example, furniture, doors, and the like) throughout the room, may be known by the virtual reality system. In some implementations, the physical boundaries and physical obstacles may be determined based on, for example, a scan of the room upon initiation of a virtual immersive experience, and calibration of the relative positions of the walls and physical objects in the room. This scan may be accomplished by, for example, a camera and/or other image processing devices such as the camera 180 and processor 190 shown in FIGS. 2A-2B and/or the sensor(s) 304 and/or 360 and the processor(s) 309 and/or 390 shown in FIG. 3. In some implementations, the physical boundaries of the room may be known based on, for example, installation of the virtual reality system in a room having a standard and/or known configuration, and the like. In some implementations, the virtual reality system may be set to detect and update physical boundaries such as walls, as well as other physical objects (both stationary and moving) such as, for example, furniture, doors (and the opening and closing of doors), other people, pets, and the like. This detection may be accomplished essentially real time, as the user approaches the boundaries and/or obstacles, for example, by the imaging devices, sensors, processors and the like described above.

In some implementations, the virtual reality system may detect and periodically update the physical position of other people, pets and the like in the room, who may be physically moving in the room as the user moves, and who may pose a physical obstacle to the user as the user moves in the room. In some situations, the other person/people in the room may also occupy the shared virtual environment with the user, and thus the user may be aware of the presence of the other person/people, but may not necessarily be aware of the physical position of the other people/person in the room, and thus pose a physical obstacle/potential physical hazard to the user. In some situations, other person/people (and/or pets) may also be in the room, but may not be engaged in the same virtual environment as the user, and/or may have entered the room after initiation of the user's virtual experience. In this case, the user is most likely not aware of their physical position in the room, and thus they pose a physical obstacle and/or potential physical hazard to the user.

In some implementations, once a physical configuration of a particular room is known (including boundaries defined by physical walls, other physical features of the room, and/or other physical obstacles in the room), a size, or extent, of the virtual environment may simply be designed and/or adapted to fit within these known physical constraints. However, imposing these types of constraints on the virtual environment may be unnecessarily limiting on a system capable of generating a significantly more extensive virtual environment, that would be otherwise capable of accommodating sharing amongst multiple users, and that would provide for more extensive user movement, exploration, and interaction.

In some implementations, as the user moves in the real world environment, and approaches a wall (either known in advance or detected real time by the system) which would limit the user's further physical movement in the real world environment, the system may cause the virtual environment to automatically scroll. This automatic scrolling of the virtual environment may cause the user to turn, in an effort to re-orient the user within the real world space, to accommodate further physical movement. In some implementations, the system may automatically cause the user to teleport, or change visual direction and/or orientation within the virtual environment. This automatic scrolling and/or teleporting may effectively re-orient the user, but in the interim may cause disorientation, making it difficult for the user to maintain presence in the virtual environment. This disconnect may be exacerbated in a situation in which multiple users are virtually present in the same, shared virtual environment.

In a system and method, in accordance with implementations described herein, a physical distance between each user and any physical obstacles and/or physical boundaries in all directions in the user's respective real world environment, or physical space, may be determined by, for example, various sensors and/or processors included in the system as described above. A representation of each user's real world environment, or physical space, may be overlaid on the virtual environment to be shared. This may allow the manner in which the virtual environment is presented to, or oriented with respect to, each user to be optimized for both physical movement in the user's respective physical, real world environment, and virtual movement in the virtual environment. That is, the virtual environment may be presented to, or oriented with respect to each user such that the user is oriented in the virtual environment based on the user's orientation in his/her respective physical space, to provide the longest unobstructed moving distance possible in the virtual environment, and/or the most clear path to other users virtually sharing the virtual space, given the known physical constraints in the physical space.

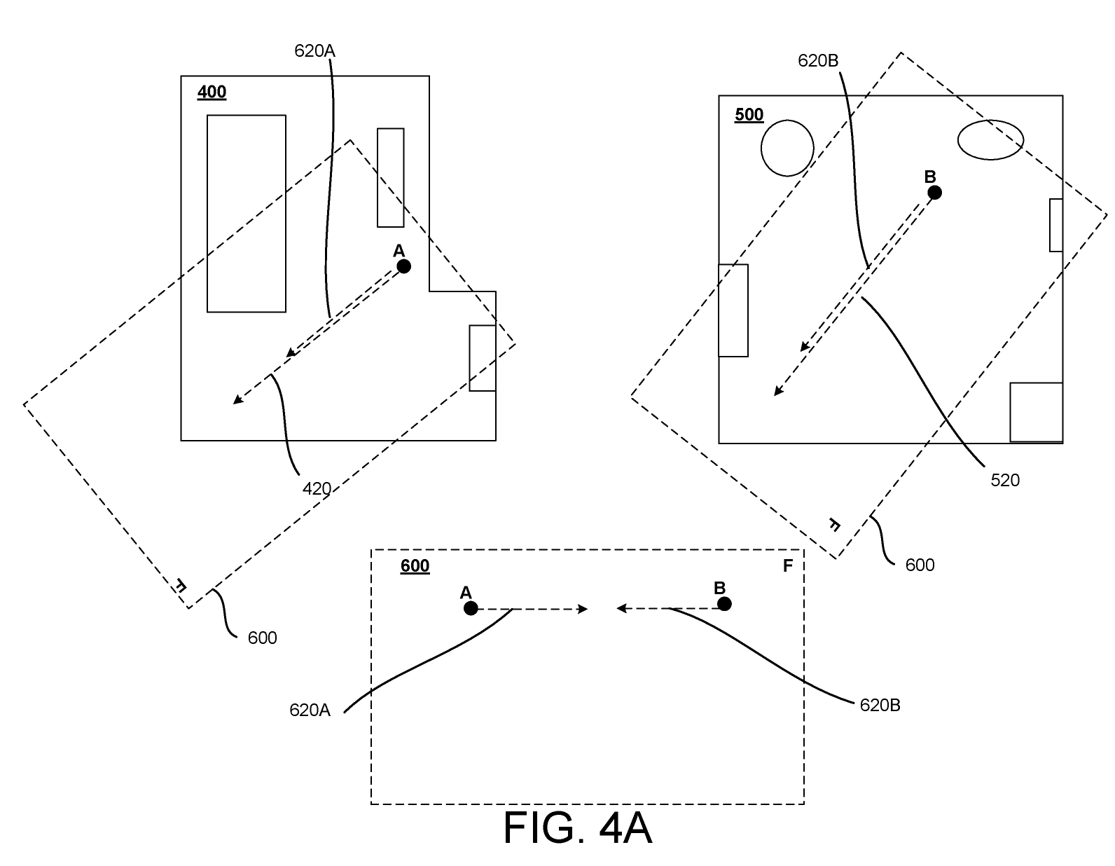

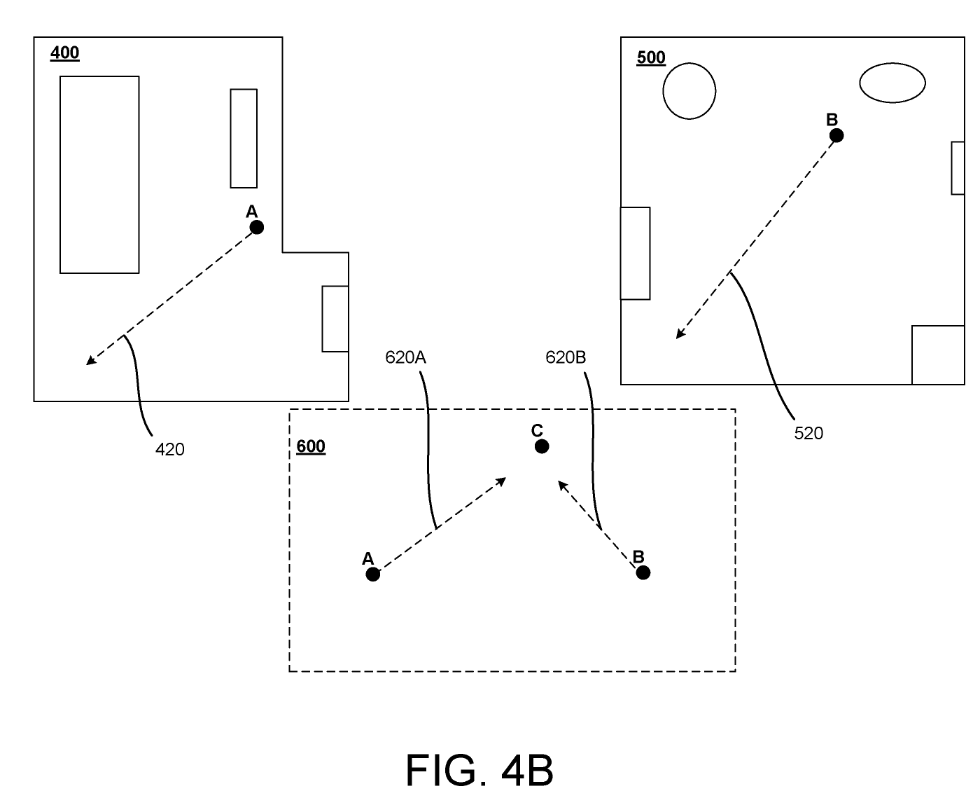

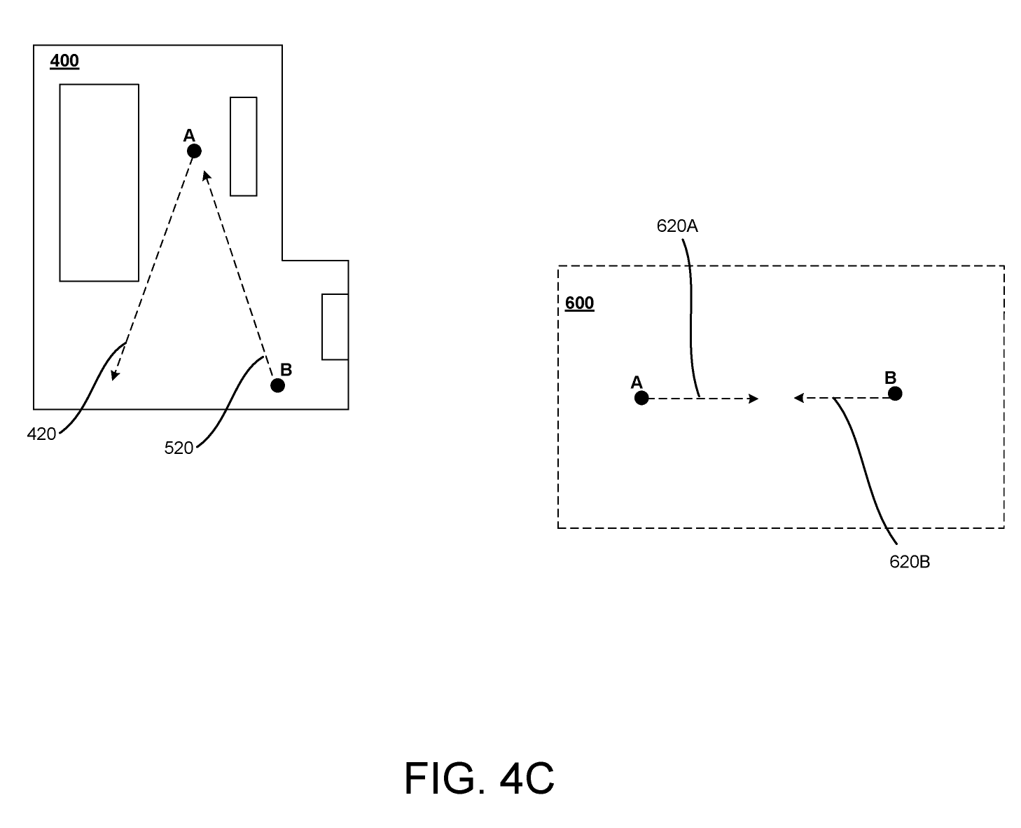

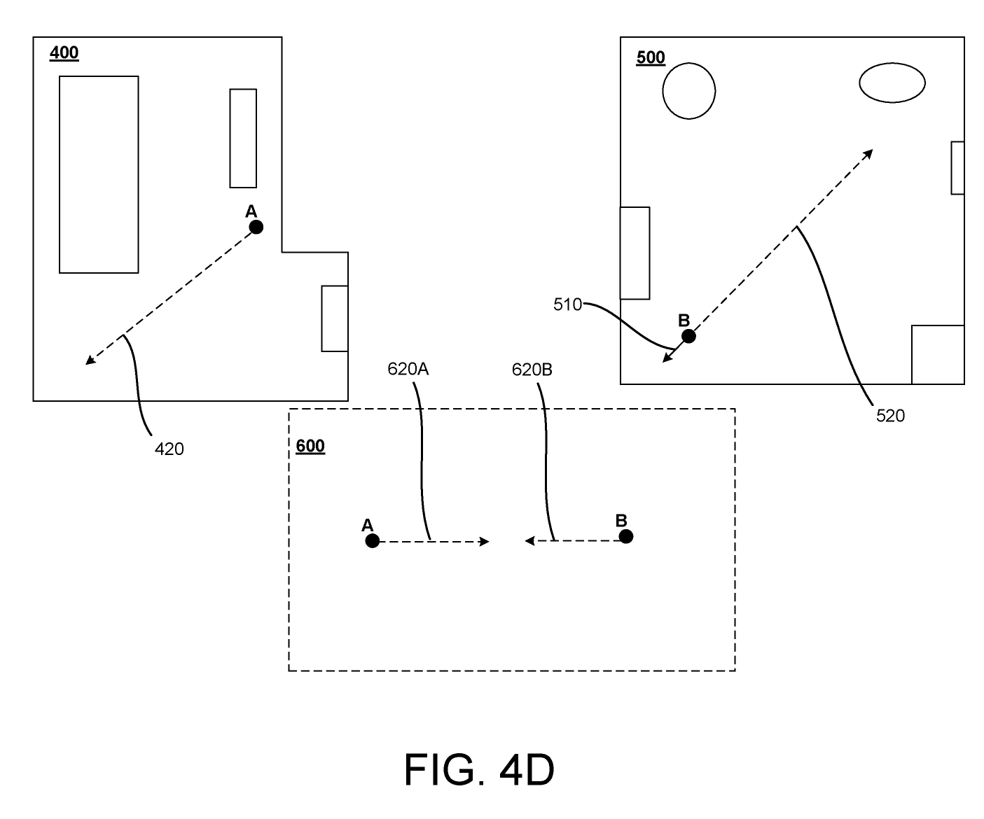

As shown in FIG. 4A, a first user A may be physically positioned in a first physical, real world environment 400, or a first room 400, or a first physical space 400. A second user B may be physically positioned in a second physical, real world environment 500, or a second room 500, or a second physical space 500 that is different from the first physical space 400. The first user A and the second user B may choose to engage in the same virtual experience together, in a future, common virtual space 600. In the common virtual space 600, the shared virtual environment may be shared by the first user A and the second user B, even though the first and second users A and B physically occupy separate physical spaces 400 and 500, respectively.

As described above, in some implementations, the physical constraints (physical boundaries, physical obstacles and the like) of the first physical space 400, and/or of the second physical space 500, may be already known by the system. In some implementations, the physical constraints (physical boundaries, physical obstacles and the like) of the first physical space 400, and/or of the second physical space 500, may be determined based on, for example, a scan of the physical space(s) 400, 500 prior to initiation of the virtual experience and presentation of the virtual environment, and in particular, the shared virtual space 600, to the users A and B. As noted above, such a scan of the physical spaces 400, 500 may be done by, for example, the camera 180 and/or other sensors on the HMD 100, sensors on the handheld electronic device 102, and/or other sensors included in the system that can capture images of the physical spaces 400, 500. As noted above, in some implementations, the physical constraints (physical boundaries, physical obstacles and the like) of the first physical space 400 and the second physical space 500 may be periodically, or intermittently updated. This may provide an essentially real time physical state of the respective physical space, should the physical obstacles in the physical space 400, 500 move or change. For example, this intermittent scanning and real time updating may provide an indication of an opening/closing door presenting a physical obstacle, another person/pet and the like moving in the physical space and/or entering the physical space, and other such physical obstacles which may move and/or change.

Whether the physical constraints of the first physical space 400 and/or the second physical space 500 are previously available based on a known configuration of the particular space, or are determined based on a scan of the physical space in response to a request to initiate a virtual experience, the system may determine a longest unobstructed path in the physical space, along which the user may move in the physical space. For example, as shown in FIG. 4A, the system may determine that the longest, least unobstructed route or path in the first physical space 400 given the current position of the first user A in the first physical space 400, is the first physical route 420, or first physical path 420, or first volume path 420. Similarly, the system may determine that the longest, least unobstructed route or path in the second physical space 500 given the current position of the second user B in the second physical space 500, is the second physical route 520, or second physical path 520, or second volume path 520, shown in FIG. 4A. The first physical path 420 and the second physical path 520 may represent a route or path through the respective physical spaces 400, 500 that are relatively clear of physical constraints which would otherwise hinder or obstruct movement of the user. Such physical constraints may include, for example, physical objects in the physical space, such as stationary physical objects occupying floor space and/or extending into the physical space which would hinder the movement of the user in the space, and the like. For example, furniture positioned on the floor of a physical space may inhibit or obstruct the user's movement through the physical space, whereas a light fixture installed on a ceiling of the physical space may not. The system may detect the objects posing physical constraints to the user's movements in the physical space, and determine the least obstructed physical route, or path, in the physical space.

The virtual environment may be oriented for presentation to the first user A based on the determined first physical path 420. Similarly the virtual environment may be oriented for presentation to the second user B based on the determined second physical path 520. This orientation of the presentation of the virtual environment to the first and second users A and B may be based on, for example, the features of a particular virtual environment to be shared by the first user A and the second user B. For example, in some implementations, the features of a particular virtual environment may lend themselves to interaction between the first user A and the second user B (for example, between a first virtual character representing the first virtual user A in the shared virtual space 600, and a second virtual character representing the second virtual user B in the shared virtual space 600).

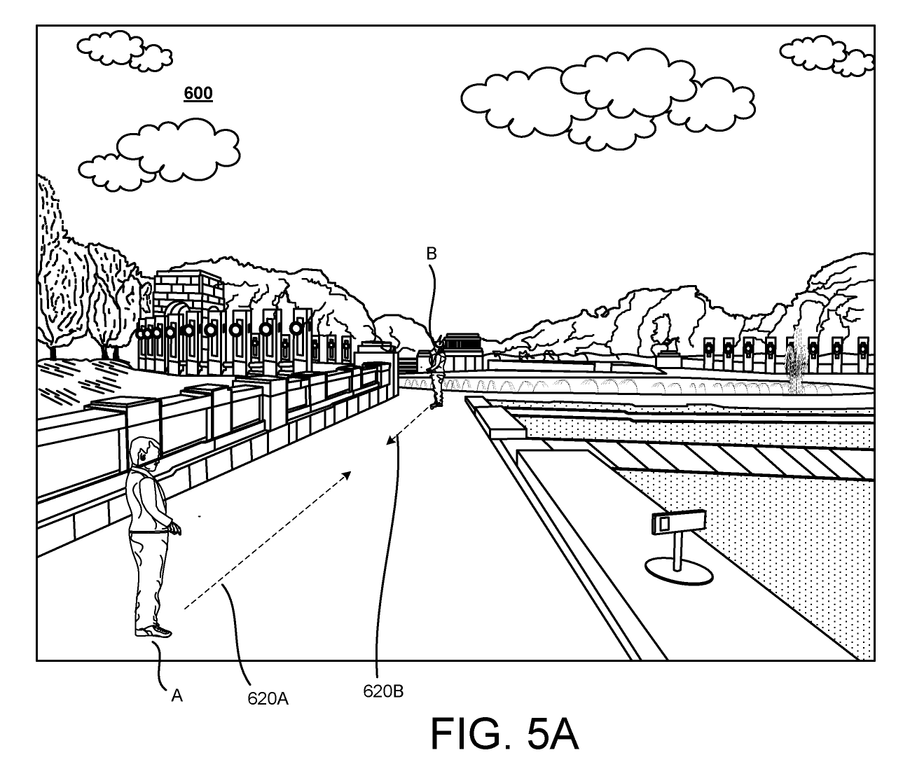

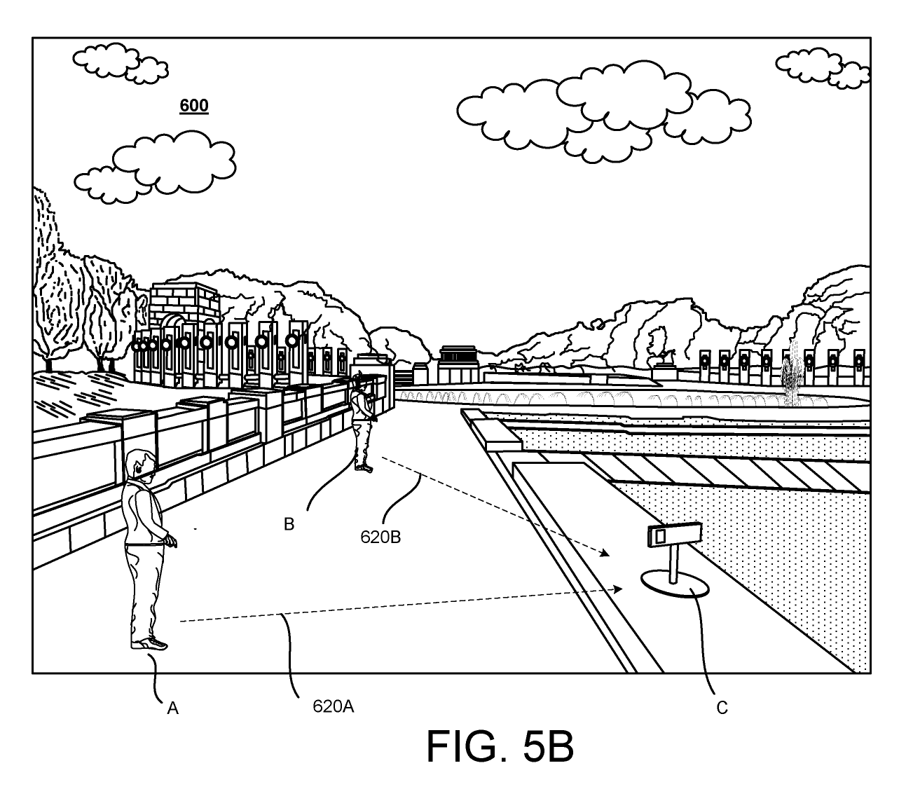

In this situation, the virtual environment, or shared virtual space 600 may be presented to the first user A with a relatively clear, and relatively unobstructed virtual route or path 620A toward the virtual representation of the second user B. The virtual features in the virtual environment in the shared virtual space 600 may be oriented with respect to the first user A such the that the first user A is naturally drawn, by the arrangement of these virtual features, in a direction corresponding to the first physical route or path 420 in the first physical space 400. This may allow the first user A to follow a relatively clear, relatively unobstructed virtual path 620A in the virtual space 600, and a relatively clear, relatively unobstructed physical path 420 in the physical space 400, in order to walk towards the virtual representation of the second user B, as shown in FIGS. 4A and 5A. Similarly, in this situation, the virtual environment, or shared virtual space 600, may be presented to the second user B with a clear, unobstructed virtual path 620B toward the virtual representation of the first user A. The virtual features in the virtual environment in the shared virtual space 600 may be oriented with respect to the second user B such that the second user B is naturally drawn by the arrangement of these virtual features in a direction corresponding to the second physical route or path 520 in the second physical space 500. This may allow the second user B to follow a clear, unobstructed virtual route or path 620B in the virtual space 600, and a clear, unobstructed physical path 520 in the physical space 500, in order to walk towards the virtual representation of the first user A, as shown in FIG. 4A and 5A.

In the example shown in FIG. 4A, the shared virtual space 600 is overlaid, in dotted lines, on the first physical space 400. In FIG. 4A, the shared virtual space 600 is also overlaid, in dotted lines, on the second physical space 500. An orientation of the shared virtual space 600 may be ascertained based on the orientation of the letter F in the representation of the shared virtual space 600 at the bottom of FIG. 4A, versus the representation of the letter F in the representation of the shared virtual space 600 overlaid on the first physical space 400, and versus the orientation of the letter F in the representation of the shared virtual space 600 overlaid on the second physical space 500. In the example shown in FIG. 4A, the presentation of the virtual environment to the first user A is oriented so as to draw the first user toward the virtual representation of the second user B, or along the first physical path 420, corresponding to the first virtual path 620A. Similarly, the presentation of the virtual environment to the first user A is oriented so as to draw the first user toward the virtual representation of the second user B, or along the second physical path 520, corresponding to the second virtual path 620B. Thus, in the example shown in FIG. 4A, opportunities for interaction between the first user A and the second user B in the virtual environment presented in the shared virtual space 600 may be maximized, within the context of a particular application generating the virtual environment.

In some implementations, the virtual environment presented in the shared virtual space 600 may be arranged to encourage interaction of the first user A and the second user B with one or more virtual objects, elements, features and the like in the virtual environment. For example, as shown in FIG. 4B, in some implementations, the first user A and the second user B may each wish to interact with a virtual object C in the virtual environment presented in the shared virtual space 600. In this situation, the virtual environment, or shared virtual space 600, may be presented to the first user A with a clear virtual path 620A toward the virtual object C. The virtual features in the virtual environment in the shared virtual space 600 may be oriented with respect to the first user A such the that the first user A is naturally drawn, for example, by the arrangement of these virtual features, in a direction corresponding to the first physical path 420 in the first physical space 400. This may allow the first user A to follow a clear virtual path 620A in the virtual space 600, and a clear physical path 420 in the physical space 400, in order to walk towards the virtual object C, as shown in FIGS. 4B and 5B. Similarly, in this situation, the virtual environment, or shared virtual space 600 may be presented to the second user B with a clear virtual path 620B toward the virtual object C. The virtual features in the virtual environment in the shared virtual space 600 may be oriented with respect to the second user B such the that the second user B is naturally drawn, for example, by the arrangement of these virtual features, in a direction corresponding to the second physical path 520 in the second physical space 500. This may allow the second user B to follow a clear virtual path 620B in the virtual space 600, and a clear physical path 520 in the physical space 500, in order to walk towards the virtual object C, as shown in FIGS. 4B and 5B.

Thus, the context of the virtual environment may cause the users to be naturally drawn in a particular direction in the virtual environment. That is, the context of the virtual environment may include, for example, whether the particular scene in the virtual environment is for interaction between the first and second users A and B, and/or for interaction of the first and second users A and B with one or more particular virtual features of the virtual environment, as well as the virtual placement of the virtual features in the virtual environment to elicit such interaction. That is, the context of the virtual environment as it is presented to the user A, including virtual placement of the virtual features with respect to the user A, may cause the user A to be naturally drawn along the first virtual path 620A (toward the user B, and/or toward the virtual element C). Similarly, the context of the virtual environment as it is presented to the user B (which may be different than the context of the same virtual environment as it is presented to the user A), including virtual placement of the virtual features with respect to the user B, may cause the user B to be naturally drawn along the second virtual path 620B (toward the user A, and/or toward the virtual element C).

In these examples, in which the user A occupies the first physical space 400 and the user B occupies the second physical space 500, the user A and the user B do not pose physical collision hazards to each other. However, another person (not engaged in the virtual environment in the shared virtual space 600), a pet and the like may enter one of the physical spaces 400 or 500. As the newly entering person/pet entering the physical space 400/500 is not in the shared virtual space 600, the user A/B in the corresponding physical space 400/500 may not become aware of the newly present person/pet in time to avoid collision, without the use of additional devices and/or detection and/or computing capability. Thus, in this type of example, the newly present person/pet may cause a collision hazard to the user A/B in the physical space 400/500. Accordingly, in some implementations, the system may intermittently/periodically scan the corresponding physical space 400/500, and update the physical constraints associated with the physical space 400/500 to include the newly present person/pet. The system may then update the path to be followed by the user A/B in the corresponding physical space 400/500, taking into consideration the newly present person/pet and/or corresponding movement of the person/pet.

In some situations, the first user A and the second user B may be physically present in the same physical space, for example, the first physical space 400, as shown in FIG. 4C. In this situation, the system may determine the longest physical path 420 in the first physical space 400 for the first user A based on the position and orientation of the first user A in the first physical space 400, as described above. Similarly, the system may determine the longest physical path 520 in the first physical space 400 for the second user B based on the position and orientation of the second user B in the first physical space 400, as described above.

The longest physical path 420 for the user A, in the first physical space 400 may be determined based on the physical constraints of the physical space 400 (for example, walls), as well as physical obstacles in the physical space 400. The physical obstacles may include, for example, stationary objects such as furniture in the physical space 400, as well as non-stationary objects such as the user B in the physical space 400. In some implementations, the physical obstacles may include the detected entry of another person into the first physical space 400, the detected entry of a pet into the physical space 400, and the like. Thus, in determining the longest physical path 420 for the user A in the physical space 400, the system may consider the user B to also be a physical obstacle to be taken into account for collision avoidance. The system may also consider the detected entry of another person or a pet to be a physical obstacle to be taken into account for collision avoidance. That is, the system may set the longest physical path 420 for the user A, also taking into account the physical path likely to be followed by the user B (for example, the longest physical path 520), as well as the detected entry of any new people, pets and the like into the physical space 400, so as to avoid collision of the user A with any of these physical obstacles in the physical space 400. Similarly. in determining the longest physical path 520 for the user B in the physical space 400, the system may consider the user A, as well as the detected entry of other people, pets and the like into the physical space 400, to also be a physical obstacle(s) to be taken into account for collision avoidance. That is, the system may set the longest physical path 520 for the user B, also taking into account the physical path likely to be followed by the user A (for example, the longest physical path 420), and the detected entry of another person/pet into the physical space, so as to avoid collision of the user B with physical obstacles in the physical space 400. This analysis may be conducted iteratively, to set the first and second paths 420 and 520 for the first and second users A and B, to avoid collision between the first and second users A and B, as well as with other people, pets and the like that may enter the physical space 400 of which the users A and B may not be aware.

The virtual environment presented in the shared virtual space 600 may then be presented in a first orientation to the first user A, and in a second orientation to the second user B, based on the respective positions and orientations of the first and second users A and B, as well as the movement paths of the first user A and the second user B in the physical space 400, to encourage interaction between the first user A and the second user B, as discussed in detail above with respect to FIGS. 4A and 5A. Similarly, the virtual environment presented in the shared virtual space 600 may then be presented in a first orientation to the first user A, and in a second orientation to the second user B, based on the respective positions and orientations of the first and second users A and B, as well as the movement paths of the first user A and the second user B in the physical space 400, to encourage interaction with one or more virtual elements in the virtual environment presented in the shared virtual space 600, as discussed above in detail with respect to FIGS. 4B and 5B.

In some implementations, when the first user A and the second user B are present in the same physical space, as described above with respect to FIG. 4C, the orientation of the virtual environment in the shared virtual space 600, or the presentation of the virtual environment in the shared virtual space 600, may be defined based on the position and orientation of the first of the multiple users to join, or enter, the shared virtual space 600. For example, the first user A in the first physical space 400, may initiate a virtual experience, and enter the virtual space 600. The features of the virtual environment presented in the virtual space 600 may be oriented so that the longest possible vector of movement for the first user A in the physical space 400, and in the virtual space 600, is provided to the first user A. If the second user B later enters the first physical space 400 (joining the first user A in the first physical space 400), and chooses to join the first user A in the virtual environment, thus sharing the virtual space 600, the presentation and orientation of the elements and features of the virtual environment in the shared virtual space 400 may remain optimized for the first user A, with the orientation of the elements and features of the virtual environment set for and presented to the second user B based on the environment already in place for the first user A.

In some situations, a user may be positioned and/or oriented in a physical space such that a physical path directly in front of the user, available for physical forward movement of the user in the physical space, is limited by one or more of the physical constraints of the room. For example, as shown in FIG. 4D, at the initiation of the virtual experience, the second user B may be oriented in the second physical space 500 such that the physical path 510 directly in front of the second user B (i.e., the physical path the second user B would follow by walking substantially forward) is somewhat limited by a physical constraint of the second physical space 500. In the example shown in FIG. 4D, the second user B is facing a wall of the second physical space 500. This may limit the amount of forward movement available along the physical path 510 corresponding to the current physical orientation of user B in the second physical space 500. When this type of physical constraint is detected, for example, within a given threshold, that would limit the physical path along which the user may move, the system may cause the user to turn (or in some manner, physical re-orient) before proceeding forward. This may re-direct the user along a longer path, such as, for example, along the second physical path 520, as shown in FIG. 4D. In some implementations, the system may cause the user to turn, or re-orient, to a desired orientation based on how the virtual features in the virtual environment are presented to the user. For example, in some implementations, the system may virtually position the virtual features with which the user is to engage behind the user, causing the user to naturally turn around to engage the virtual features. In some implementations, the system may cause the user to turn based on audio and/or visual cues, guides and the like. In some implementations, the system may cause the user to turn based on an arrangement of virtual features in the virtual environment together with audio cues and/or visual cues.

The example shown in FIG. 4D illustrates the first user A in the first physical space 400, and the second user B in the second physical space 500, separate from the first physical space 400. However, the principles described above may be applied if the first user A and the second user B are in the same physical space, for example, as described above with respect to FIG. 4C.

The examples described above with respect to FIGS. 4A-4D and 5A-5B include a first user and a second user, simply for ease of discussion and illustration. The principles described herein may be applied to situations in which only one user occupies the virtual space, or when two, or more users occupy the same virtual space. Similarly, the multiple users may occupy the same physical space, different individual physical spaces, or combinations thereof.

In a system and method, in accordance with implementations described herein, a first user A and a second user B engaged in a shared virtual environment presented in a shared virtual space 600, as described above with respect to FIGS. 4A-4D, may have the opportunity for maximized interaction and movement in the shared virtual space 600. An overlay of a first physical space 400 (and a position of the first user A in the first physical space 400) and a second physical space 500 (and a position of the second user B in the second physical space 500) may be used by the system to define an orientation for the presentation of the virtual environment to the first and second users A and B in the shared virtual space 600. This may allow for movement of the first and second users along respective longest possible physical paths in the physical spaces 400 and 500, and along desired virtual paths in the shared virtual space 600, as the first and second users A and B move through the first and second physical spaces 400 and 500 (or the first and second users A and B move through the first physical space 400, as shown in FIG. 4C), and through the shared virtual space 600.

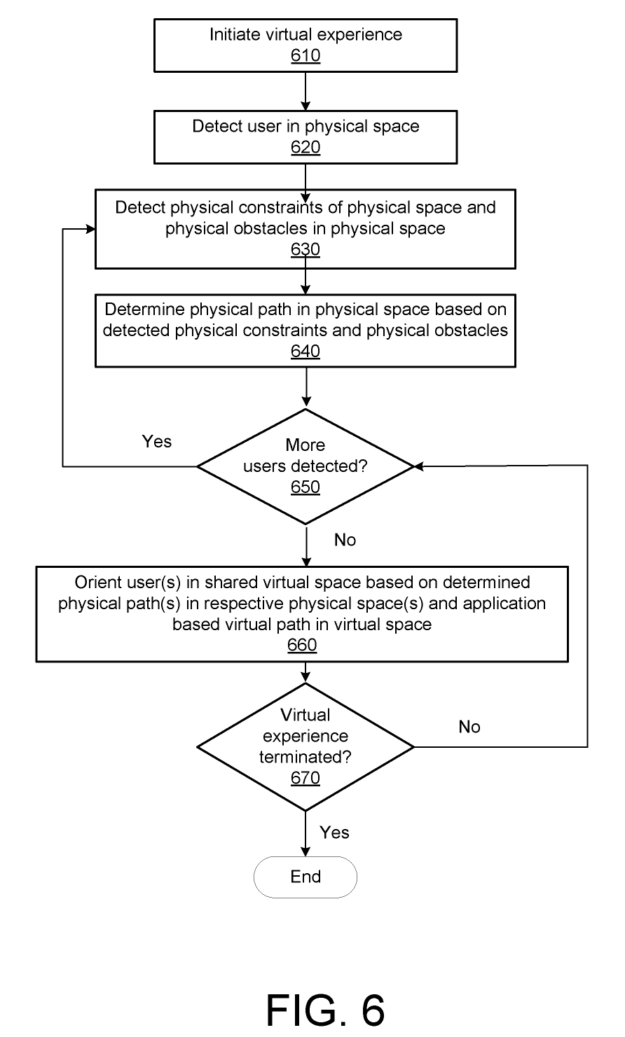

A flowchart of the processes described above with respect to FIGS. 4A-4D and 5A-5B is shown in FIG. 6. A user in a physical space may operate an augmented and/or virtual reality system to generate a virtual environment to be experienced in a virtual space (block 610). The system may detect physical constraints associated with the physical space in which the user is physically present, and physical objects posing physical obstacles in the physical space (block 620). This may include, for example, a scan of the physical space, accessing previously stored physical constraints of the physical space and obstacles associated with the known physical space, and the like. This may include the detection of other users in the same physical space, posing potential collision obstacles in the physical space. Based on the physical constraints and physical obstacles associated with the physical space, the system may generate a physical path in the physical space which may provide the user with the longest physical path in the physical space (block 640). Upon detection of more users physically present in a physical space (block 650), the system may detect physical constraints and physical obstacles associated with the respective physical space of each individual user (block 630) and generate a corresponding longest physical path for each individual user (block 640). The system may then overlay the physical constraints and physical obstacles of each physical space and longest path of each individual user to determine an orientation of the virtual environment to be presented to each user in the shared virtual space to maximize a desired interaction, depending on a context of a particular application (block 660). This process may continue until the virtual experience is terminated (block 670).

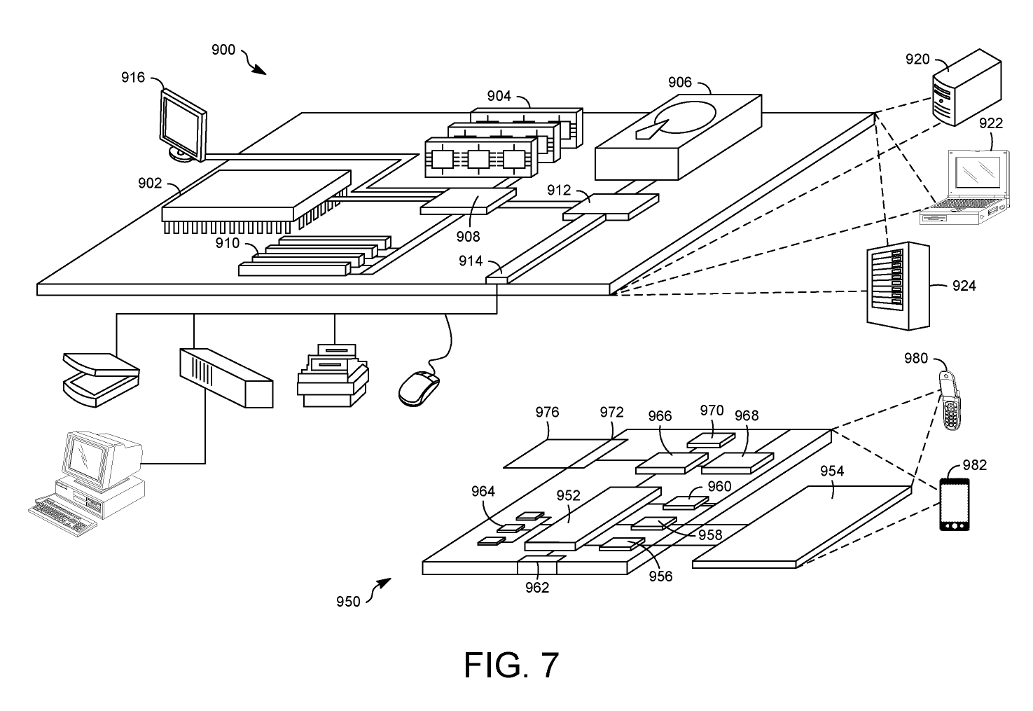

FIG. 7 shows an example of a generic computer device 900 and a generic mobile computer device 950, which may be used with the techniques described here. Computing device 900 is intended to represent various forms of digital computers, such as laptops, desktops, tablets, workstations, personal digital assistants, televisions, servers, blade servers, mainframes, and other appropriate computing devices. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. The processor 902 can be a semiconductor-based processor. The memory 904 can be a semiconductor-based memory. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, various modifications may be made without departing from the spirit and scope of embodiments as broadly described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
detecting at least one physical constraint associated with a first physical space;
detecting, based on a position and an orientation of a first user in the first physical space and the detected at least one physical constraint associated with the first physical space, a first physical path in the first physical space;
detecting at least one physical constraint associated with a second physical space;
detecting, based on a position and an orientation of a second user in the second physical space and the detected at least one physical constraint associated with the second physical space, a second physical path in the second physical space;
displaying a virtual environment to the first user at a first orientation with respect to the first user, and displaying the virtual environment to the second user at a second orientation with respect to the second user, the virtual environment being presented to the first and second users in a shared virtual space, including:
orienting virtual features of the virtual environment with respect to the first user in the shared virtual space based on the first physical path, a context of the virtual environment presented in the shared virtual space, and a first virtual path in the shared virtual space; and
orienting the virtual features of the virtual environment with respect to the second user in the shared virtual space based on the second physical path, the context of the virtual environment presented in the shared virtual space, and a second virtual path in the shared virtual space.

2. The method of claim 1, wherein the second physical space is different from the first physical space.

3. The method of claim 1, wherein the second physical space is the same as the first physical space.

4. The method of claim 1, wherein displaying the virtual environment to the first user at the first orientation, and displaying the virtual environment to the second user at the second orientation includes:
orienting the display of the virtual features of the virtual environment with respect to the first user such that the first physical path and the first virtual path provide the first user with an unobstructed physical path and an unobstructed virtual path to the second user and
orienting the display of the virtual features of the virtual environment with respect to the second user such that the second physical path and the second virtual path provide the second user with an unobstructed physical path and an unobstructed virtual path to the first user.

5. The method of claim 1, wherein
detecting the at least one physical constraint associated with the first physical space includes:
scanning the first physical space and detecting physical boundaries of the first physical space and physical obstacles positioned within the first physical space, and mapping the first physical space based on the detected boundaries and detected obstacles, and wherein detecting the at least one physical constraint associated with the second physical space includes:
scanning the second physical space and detecting physical boundaries of the second physical space and physical obstacles positioned within the second physical space, and mapping the second physical space based on the detected boundaries and detected obstacles.

6. The method of claim 5, wherein
detecting the first physical path includes detecting a longest unobstructed physical path in the first physical space for movement of the first user in the first physical space based on the detected physical boundaries of the first physical space and the physical obstacles detected in the first physical space, and
detecting the second physical path includes detecting a longest unobstructed physical path in the second physical space for movement of the second user in the second physical space based on the detected physical boundaries of the second physical space and the physical obstacles detected in the second physical space.

7. The method of claim 1, wherein
detecting the at least one physical constraint associated with the first physical space includes detecting physical boundaries of the first physical space, and
detecting the at least one constraint associated with the second physical space includes detecting physical boundaries of the second physical space.

8. The method of claim 7, wherein
detecting the at least one physical constraint associated with the first physical space includes detecting one or more physical obstacles in the first physical space, and
detecting the at least one constraint associated with the second physical space includes detecting one or more physical obstacles the second physical space.

9. The method of claim 8, wherein
detecting one or more physical obstacles in the first physical space includes:
intermittently scanning the first physical space;
comparing a previous scan of the first physical space to a current scan of the first physical space; and
updating positions of physical obstacles in the first physical space based on the comparison, and
detecting one or more physical obstacles in the second physical space includes:
intermittently scanning the second physical space;
comparing a previous scan of the second physical space to a current scan of the second physical space; and
updating positions of physical obstacles in the second physical space based on the comparison.

10. The method of claim 9, wherein
updating positions of physical obstacles in the first physical space includes detecting movement of a previously detected physical obstacle in the first physical space or a new physical obstacle in the first physical space, and
updating positions of physical obstacles in the second physical space includes detecting movement of a previously detected physical obstacle in the second physical space or a new physical obstacle in the second physical space.

11. The method of claim 10, wherein the second physical space is the same as the first physical space, and wherein
updating positions of physical obstacles in the first physical space includes updating a position of the second user relative to the first user in the first physical space, and
updating positions of physical obstacles in the second physical space includes updating a position of the first user relative to the second user in the second physical space.

12. A computer program product embodied on a non-transitory computer readable medium, the computer readable medium having stored thereon a sequence of instructions which, when executed by a processor, causes the processor to execute a method, the method comprising:
detecting at least one physical constraint associated with a first physical space;
detecting a first physical path in the first physical space based on a position and an orientation of a first user in the first physical space and the detected at least one physical constraint associated with the first physical space;
detecting at least one physical constraint associated with a second physical space;
detecting a second physical path in the second physical space based on a position and an orientation of a second user in the second physical space and the detected at least one physical constraint associated with the second physical space;
displaying virtual features of a virtual environment to the first user in a first orientation; and
displaying the virtual features of the virtual environment to the second user in a second orientation,
the virtual environment being presented to the first and second users in a shared virtual space,
the first orientation of the virtual features of the virtual environment with respect to the first user in the shared virtual space being based on the first physical path, a context of the virtual environment, and a first virtual path in the shared virtual space, and
the second orientation of the virtual features of the virtual environment with respect to the second user in the shared virtual space being based on the second physical path, the context of the virtual environment presented in the shared virtual space, and a second virtual path in the shared virtual space.

13. The computer program product of claim 12, wherein the second physical space is different from the first physical space.

14. The computer program product of claim 12, wherein displaying the virtual environment to the first user at the first orientation, and displaying the virtual environment to the second user at the second orientation includes:
orienting the display of the virtual features of the virtual environment with respect to the first user such that the first physical path and the first virtual path provide the first user with an unobstructed physical path and an unobstructed virtual path to the second user and
orienting the display of the virtual features of the virtual environment with respect to the second user such that the second physical path and the second virtual path provide the second user with an unobstructed physical path and an unobstructed virtual path to the first user.

15. The computer program product of claim 12, wherein
detecting the at least one physical constraint associated with the first physical space includes:
scanning the first physical space and detecting physical boundaries of the first physical space and physical obstacles positioned within the first physical space, and mapping the first physical space based on the detected boundaries and detected obstacles, and wherein
detecting the at least one physical constraint associated with the second physical space includes:
scanning the second physical space and detecting physical boundaries of the second physical space and physical obstacles positioned within the second physical space, and mapping the second physical space based on the detected boundaries and detected obstacles.

16. The computer program product of claim 15, wherein
detecting the first physical path includes detecting a longest unobstructed physical path in the first physical space for movement of the first user in the first physical space based on the detected physical boundaries of the first physical space and the physical obstacles detected in the first physical space, and
detecting the second physical path includes detecting a longest unobstructed physical path in the second physical space for movement of the second user in the second physical space based on the detected physical boundaries of the second physical space and the physical obstacles detected in the second physical space.

17. The method of claim 12, wherein
detecting the at least one physical constraint associated with the first physical space includes:
detecting physical boundaries of the first physical space; and
detecting one or more physical obstacles in the first physical space; and
detecting the at least one constraint associated with the second physical space includes:
detecting physical boundaries of the second physical space; and
detecting one or more physical obstacles the second physical space.

18. The computer program product of claim 17, wherein
detecting one or more physical obstacles in the first physical space includes:
intermittently scanning the first physical space;
comparing a previous scan of the first physical space to a current scan of the first physical space; and
updating positions of physical obstacles in the first physical space based on the comparison, and
detecting one or more physical obstacles in the second physical space includes:
intermittently scanning the second physical space;
comparing a previous scan of the second physical space to a current scan of the second physical space; and
updating positions of physical obstacles in the second physical space based on the comparison.

19. The computer program product of claim 18, wherein
updating positions of physical obstacles in the first physical space includes detecting movement of a previously detected physical obstacle in the first physical space or a new physical obstacle in the first physical space, and
updating positions of physical obstacles in the second physical space includes detecting movement of a previously detected physical obstacle in the second physical space or a new physical obstacle in the second physical space.

20. The computer program product of claim 19, wherein the second physical space is the same as the first physical space, and wherein
updating positions of physical obstacles in the first physical space includes updating a position of the second user relative to the first user in the first physical space, and
updating positions of physical obstacles in the second physical space includes updating a position of the first user relative to the second user in the second physical space.
